(19) United States
(12) Patent Application Publication
(10) Pub. No.: US 2010/0290230 A1
(43) Pub. Date: Nov. 18, 2010

(54) Protective Light Filters and Illuminants Having Customized Spectral Profiles

(76) Inventor: Carl W. Dirk, El Paso, TX (US)

Correspondence Address: FULBRIGHT & JAWORSKI L.L.P., 600 CONGRESS AVE., SUITE 2400, AUSTIN, TX, 78701, US

(21) Appl. No.: 12/466,589

(22) Filed: May 15, 2009

(51) Int. Cl. F21V 9/00; G02B 5/20

(52) U.S. Cl. 362/293; 359/885; 359/359

(57) ABSTRACT

Customized spectral profiles, and filters and illuminants having customized spectral profiles.

This application incorporates by reference each of: (1) U.S. patent application Ser. No. 10/688,200 entitled “Customizable Spectral Profiles for Filtering,” by Carl W. Dirk, which was filed on Oct. 17, 2003; and (2) U.S. patent application Ser. No. 11/232,442 entitled “Illumination Sources and Customizable Spectral Profiles,” by Carl W. Dirk, which was filed on Sep. 21, 2005.

### BACKGROUND

1. Field of the Invention

The present invention relates generally to optics, spectroscopy, and illumination sources. More particularly, but not by way of limitation, the present invention relates to customized spectral profiles and filters and illuminants having customized spectral profiles. Representative embodiments relate to customized spectral profiles that, when incorporated into a filter or illuminant, may be used for (a) protecting works of art or other objects that may be susceptible to photochemical degradation, and/or (b) aesthetically rendering objects. Representative embodiments may also relate to predicting lighting spectral profiles optimal for illuminants such that illuminants can be configured to consume and/or emit less power.

2. Background Information

It is known that the quality of light falling upon a work of art affects the degree to which that work of art will be damaged through photochemical processes. Photodamage of works of art, in turn, is an important concern not only for the financial well-being of museums, but also for the preservation of this and foreign cultures.

One of the most common methods to minimize photodamage is to minimize the amount of ultraviolet and/or infrared radiation that impacts artwork. Although this method may be somewhat effective, it unfortunately does not prevent damage to the artwork imposed by photons that do not significantly affect the color rendering of that artwork. In other words, today's solutions do not block visible-light photons that do not contribute to the visualization of the object. Put yet another way, today's solutions are not equipped to render only the necessary portions of photometric light—transmit visible-light photons that significantly affect the visualization of a particular object (e.g., light necessary for proper color rendering) while blocking photons unneeded for this task.

It is also known that the quality of light falling upon a work of art affects the aesthetics or color rendering of that art. For instance, illumination by fluorescent lighting may give a work of art a different “look and feel” than when the art is illuminated by incandescent lighting. While the underlying physical reasons for this difference are relatively complex, existing filters and illuminants may be ill-equipped to aesthetically render an object while simultaneously protecting the object. In particular, existing filters and illuminants are generally not equipped to simultaneously render and protect an object such as a piece of art as well as may be achieved. Accordingly, many times, if a piece of art is well-protected, museum patrons cannot fully appreciate the colors of the artwork, such as, example, the way in which the artist himself or herself saw a particular work of art as it was being painted. Conversely, if a piece of art is illuminated such that the colors are more fully rendered, the artwork may not be as well protected as it could be such that the piece of art may be subject to photochemical damage at a faster rate than is otherwise desired.

U.S. Pat. No. 6,309,753, filed Aug. 9, 1999, and issued Oct. 30, 2001, to Grossman et al., is incorporated by reference to the extent it may disclose certain materials and/or compositions that may be useful in manufacturing certain embodiments of the present filters and/or illuminants.

These issues with today's technology are not meant to constitute an exhaustive list nor to limit the applications or features in this disclosure. Rather, they illustrate by example a need for the customized spectral profiles, filters, and illuminants of this disclosure.

### SUMMARY OF THE INVENTION

The present disclosure includes various embodiments of methods, customized spectral profiles, and filters and illuminants having customized spectral profiles for protecting an illuminated object such as a work of art. Various embodiments of the present disclosure may be described with reference to a source illuminant and/or a reference illuminant. Source and/or reference illuminants can comprise any suitable illuminants, such as, for example, lamp or bulb illuminants (e.g., Sylvania 58562 lamp, etc.), theoretical reference illuminants (e.g., Standard A, etc.), sunlight, candles, oil lamps, and/or any other suitable illuminants.

Some embodiments of the present filters comprise: a substrate; a plurality of first filter layers comprising a first material, one of the first filter layers in direct contact with the substrate; and a plurality of second filter layers comprising a second material; where at least a portion of the first filter layers and at least a portion of the second filter layers are coupled in an alternating configuration; and where the filter is configured to have a lumens/watt efficiency of more than about 170% and a color rendering index (CRI) of more than about 90, for a source illuminant relative to an unfiltered reference illuminant.

In some embodiments of the present filters, the unfiltered reference illuminant is an incandescent lamp having a color temperature of about 3000K. In some embodiments, the filter is further configured to have a power transmission (e.g., relative to an unfiltered source illuminant or unfiltered reference illuminant) of about between about 50% and about 60%. In some embodiments, the filter is further configured to have a power transmission (e.g., relative power transmission) of between about 54% and about 56%. In some embodiments, at least one of the source illuminant and the unfiltered reference illuminant comprises one or more light-emitting diodes (LEDs).

In some embodiments of the present filters, the substrate is configured to transmit light having a wavelength above about 400 nanometers (nm) and to substantially block light having a wavelength below about 400 nm; the first filter layers each comprise Niobium (Nb); the second filter layers each comprises Silicone (Si); and the filter is substantially stable at temperatures of at least degrees Celsius. In some embodiments, the first filter layers each comprise Nb₂O₅ and/or the second filter layers each comprise Si0₂. In some embodiments, the substrate comprises Corning 8511 glass.

In some embodiments of the present filters, each of the first filter layers has a thickness between about 5 nanometers (nm) and about 500 nm; and each of the second filter layers has a thickness of between about 5 nm and about 500 nm. In some embodiments, the plurality of first filter layers comprise ten or more first filter layers; and the plurality of second filter layers comprise ten or more second filter layers. In some embodiments, the plurality of first filter layers comprise fifteen or more first filter layers; and the plurality of second filter layers comprise fifteen or more second filter layers.

In some embodiments of the present filters, the filter is configured such that if light is incident on the filter from a source illuminant, the filter will: (a) block at least 95% of light having a wavelength below about 400 nanometers; (b) block at least 95% of light having a wavelength above about 700 nm; (c) block less than 20% of light having a wavelength between 450 nm and 630 nm and between 530 nm and 570 nm; and (d) block between about 25% and about 35% of at least one wavelength of light having a wavelength between about 530 nm and about 570 nm. In some embodiments, the filter is configured such that if light is incident on the filter from a source illuminant, the filter will block between about 25% and about 35% of at least one wavelength of light having a wavelength between about 545 nm and about 555 nm. In some embodiments, the unfiltered reference illuminant is an incandescent lamp having a color temperature of about 3000K, and where the filter is configured such that if light is incident on the filter from a source illuminant, the filter will block between about 25% and about 35% of light having a wavelength between about 545 nm and about 555 nm.

Some embodiments of the present filters are further configured to have a CRI of more than 95.

Some embodiments of the present filters are configured such that the filtering and mechanical properties of the filter are substantially stable through at least 200 on/off cycles in which the filter is disposed within 12 inches of an incandescent lamp, where each on/off cycle includes one hour during which the lamp is on and one hour during which the lamp is off, and where during the on portion of an on/off cycle the lamp reaches a maximum temperature of at least 180 degrees Celsius.

Some embodiments of the present filters are photopic filters configured such that if light is incident on the filter from a source illuminant, the filter will block substantially all non-visible light, and will have a lumens/watt efficiency of more than about 170% and a color rendering index of more than about 90, relative to an unfiltered incandescent lamp having a color temperature of about 3000K.

Some embodiments of the present illuminants have a customized spectral profile, and comprise: one or more light sources; a plurality of first filter layers comprising a first material; and a plurality of second filter layers comprising a second material; where at least a portion of the first filter layers and at least a portion of the second filter layers are coupled in an alternating configuration; and where the illuminant is configured to have a lumens/watt efficiency of more than about 170% and a color rendering index (CRI) of more than about 90, relative to an unfiltered reference illuminant that comprises an incandescent lamp having a color temperature of about 3000K.

In some embodiments of the present illuminants, the one or more light sources comprise three or more light-emitting diodes (LEDs). In some embodiments, the one or more light sources comprise more than three LEDs. In some embodiments, the one or more light sources comprise an incandescent lamp.

In some embodiments of the present illuminants, the one or more light sources comprise a substrate, and where one of the first filter layers is in direct contact with the substrate. In some embodiments, the first filter layers and second filter layers are spaced apart from the one or more light sources.

Any embodiment of any of the present methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 depicts an unfiltered illuminant and a filtered illuminant.

FIG. 2 depicts a theoretical customized spectral profile.

FIG. 3 depicts an embodiment of a filter configuration.

FIG. 4 depicts a bar chart illustrating the thicknesses of the layers for a prototype filter having the configuration of FIG. 3.

FIG. 5 depicts a model customized spectral profile as modeled for the prototype filter, and an experimental customized spectral profile as measured for the prototype filter.

FIG. 6 depicts the experimental customized spectral profile of the prototype filter.

FIG. 7 depicts a radiant intensity profile for an unfiltered incandescent illuminant, and a radiant intensity profile for the same illuminant filtered with the prototype filter.

FIG. 8 depicts a color rendering index (CRI) at a variety of beam angles for two illuminants and of the prototype filter.

FIG. 9 depicts the customized spectral profile of the prototype filter throughout accelerated ageing testing.

FIG. 10 depicts the customized spectral profile of the prototype filter throughout accelerated thermo-mechanical stress testing.

FIGS. 11A and 11B depict reflection spectra curves for photochemical changes in a pigment for the prototype filter and a comparison filter, respectively, at 0 hours and 166 hours.

FIG. 12 depicts equal-luminosity radiance profiles for each of the prototype filter and the comparison filter.

FIG. 13 depicts a color difference comparison between the prototype filter and the comparison filter for a variety of pigments after a 100-year ageing simulation.

FIG. 14 depicts color difference curves for a Blue Wool 1 pigment sample under unfiltered incandescent light and under incandescent light filtered through the prototype filter.

FIG. 15 depicts color difference curves for a Blue Wool 1 pigment sample under unfiltered incandescent light and under incandescent light filtered through the prototype filter.

FIG. 16 depicts another embodiment theoretical customized spectral profile.

FIGS. 17-27 depict reflection spectra for a variety of representative old master drawings, such as, for example, created during the period 1500-1900 CE.

### DESCRIPTION OF ILLUSTRATIVE EMBODIMENTS

The term “coupled” is defined as connected, although not necessarily directly, and not necessarily mechanically; two items that are “coupled” may be integral with each other. The terms “a” and “an” are defined as one or more unless this disclosure explicitly requires otherwise. The terms “substantially,” “approximately,” and “about” are defined as largely but not necessarily wholly what is specified, as understood by a person of ordinary skill in the art.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a filer that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps. For example, in a filter that comprises a substrate, a plurality of first filter layers, and a plurality of second filter layers, the filter includes the specified elements but is not limited to having only those elements. For example, such a method could also include a plurality of third filter layers.

Further, a device or structure that is configured in a certain way is configured in at least that way, but it can also be configured in other ways than those specifically described.

Referring now to the drawings, and more particularly to FIG. 1, shown therein for introduction is a first person 10 and a second person 14. First person 10 is shown viewing a first object 18 (e.g., a piece of artwork) by the light 22 of a first source illuminant 26. Second person 14 is shown viewing a second object 30 by the light 34 of a second source illuminant 38 that has passed through a filter 42 (i.e., second object 30 is illuminated by filtered light 46. Although first source illuminant 26 may illuminate first object 18 sufficiently for viewing, it may also provide an excess of light or photons that may damage object 18. As such, filter 42 is configured to have a customized spectral profile that filters out or substantially blocks at least a portion of light 38 from second source illuminant 38. Although filter 42 is shown separate from second source illuminant 38, it should be understood that a filter (e.g., filter 42) can be coupled to or integral to an illuminant (e.g., second illuminant 38). For example, one or more filter layers can be coupled to a source illuminant (e.g., one or more of 3 LEDs can each be coated with one or more filter layers such that the combination of LEDs and/or filter layers are together configured to emit light having a customized spectral profile).

Through methods such as, for example, the methods described in the Dirk patent applications incorporated by reference above, customized spectral profiles can be generated or developed to have desirable illumination characteristics. Such customized spectral profiles can, for example, be incorporated into a filter (e.g., a filter can be formed or configured to have a customized spectral profile that is about equal to or substantially similar to the customized spectral profile, or be incorporated into an illuminant (e.g., an illuminant can be formed or configured to have a customized spectral profile that is about equal to or substantially similar to the customized spectral profile, e.g., by way of multiple illuminants, one or more filter layers, or the like).

A number of references, factors, and characteristics of illumination and/or spectra may be useful for characterizing the customized spectral profiles, filters, and/or illuminants of the present disclosure. “Reference illuminants” can include established theoretical references (e.g., standard A illuminant, standard D65 illuminant, standard F7 illuminant), and/or one or more actual illuminants (e.g., incandescent or fluorescent illuminants, such as are manufactured or distributed by Sylvania throughout the United States). As will be understood by those of ordinary skill in the art standards A, D65, and F7 are well known theoretical reference illumination spectra, with: standard A representing an incandescent illuminant with a color temperature of about 3000K (e.g., more-modernly calculated as about 2856K); standard D65 representing daylight, and standard F7 representing a fluorescent illuminant with a broad-band daylight-imitating spectrum.

“Luminosity” or “luminous intensity” refers to perceived brightness of illumination. Luminosity can, for example, be calculated using (1) the Standard Vision Theory model in which luminosity is determined from luminance (Y), which is itself derived from the Photopic function; (2) the Helmholtz-Kohlrausch model in which luminosity may be determined from luminance (Y) and chromaticity (x,y); and/or (3) the opponent color theory in which luminosity may be determined from L*a*b* coordinates.

“Radiant power ratio” refers to the illumination per unit of power (lumens divided by watts of power) for an illuminant relative to a reference illuminant (e.g., Standard A 3000K incandescent illuminant). For example, where Standard A is the reference illuminant, Standard D65 has a radiant power ratio of about 1.27, and Standard F7 has a radiant power ratio of about 1.63. Since excess power may be more likely to increase photochemical damage, it may be desirable in some instances to reduce transmitted power. However, in order to reduce power while maintaining suitable illumination, it may be desirable in such instances to have a relatively high radiant power ratio. “Lumens/watt efficiency” is used in this disclosure as a percentage value based on the radiant power ratio of an illuminant. For example, where Standard A is the reference illuminant, Standard D65 has a lumens/watt efficiency of about 127%, and Standard F7 has a lumens/watt efficiency of about 163%.

“Color Difference” refers to a just-perceptible difference in color, i.e.,: ΔE=DE=1. Color difference can be determined using: (1) the pre-L*a*b* color difference formula which is based on UVW in the 106-CIE Yuv coordinate system Pre-Lab Color Difference is UVW in the 106-CIE Yuv coordinate system; (2) the DE76 color difference formula; (3) the DE94 color difference formula, and/or the DE00 color difference formula.

“Adaptation” refers to the ability and tendency of the eye and/or human brain to adapt to become adapted to a first color or color scheme such that when a second color or color scheme is introduced, the second color or color scheme is perceived differently than it may have been without the preceding color or color scheme. Adaptation can be determined or approximated (e.g., for color rendering models or determinations, as described in more detail below) using: (1) the von Kries model, which is used in the CIE-recommended color-rendering method of CIE 13.3; (2) the Bradford model, which may be used by Adobe Photoshop; and/or (3) the Nayatani Model given by CIE 109.2. The Nayatani model may be especially useful, accurate, and/or advantageous for widely different spectral distributions, differing color temperatures, and/or differing luminosities.

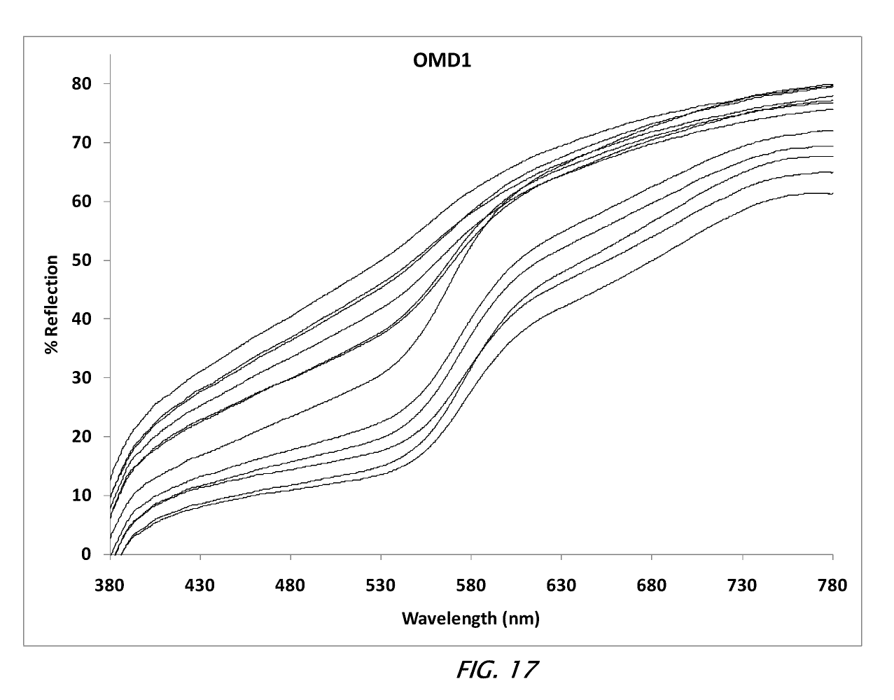

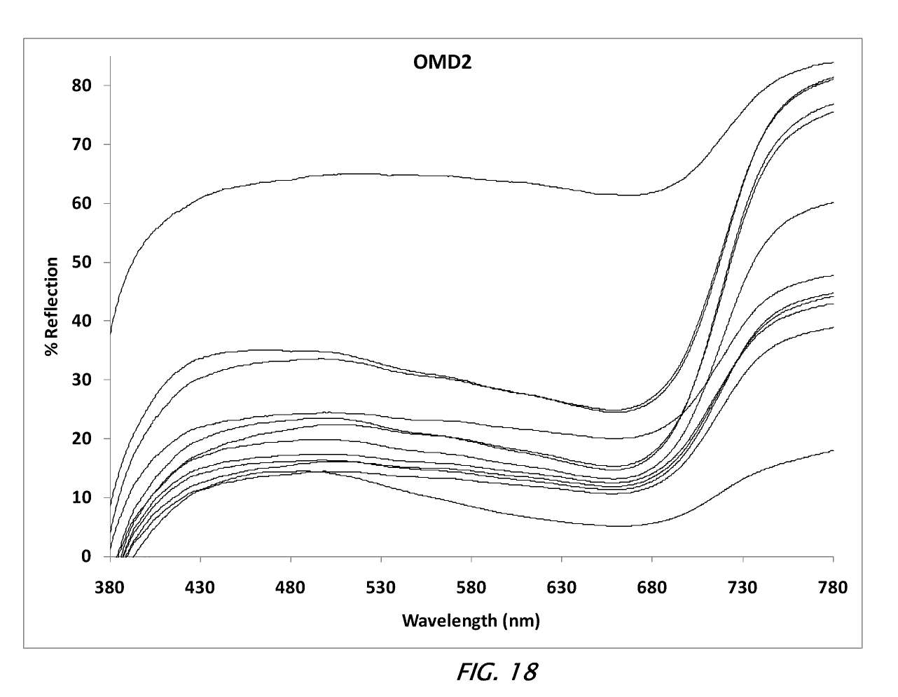

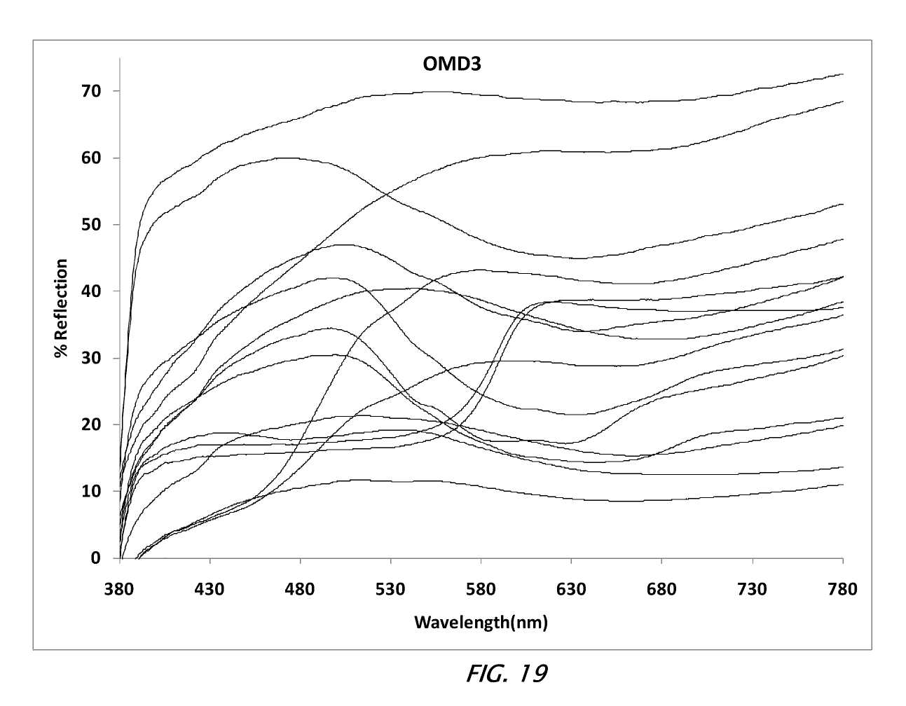

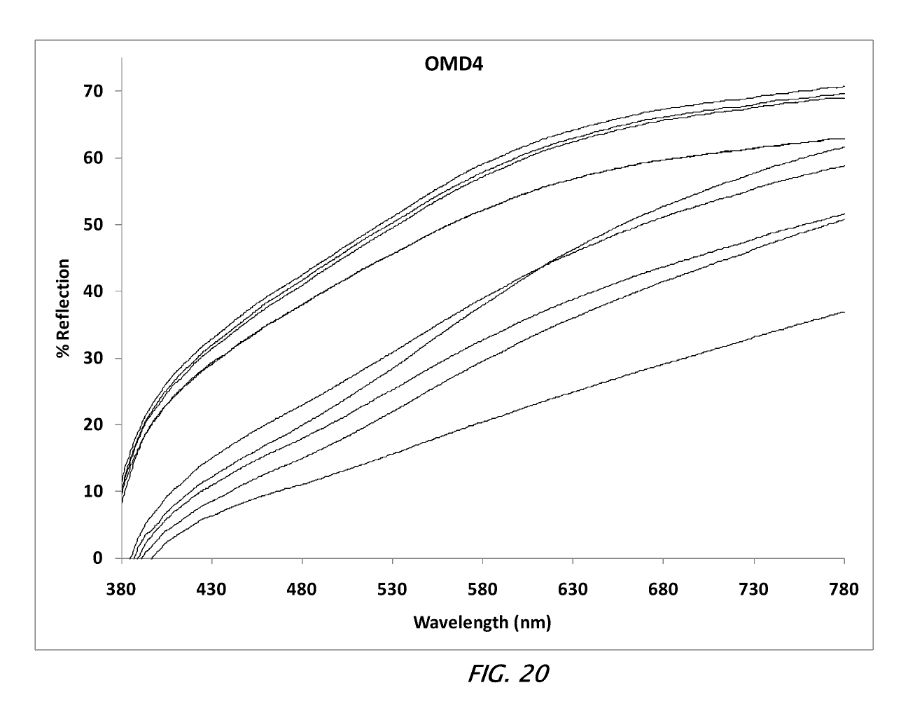

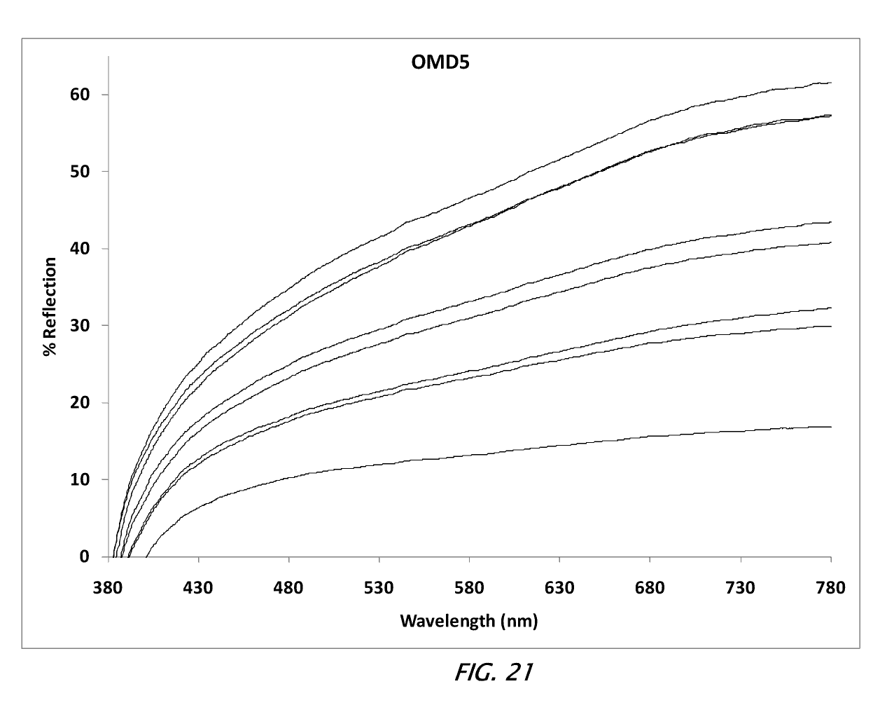

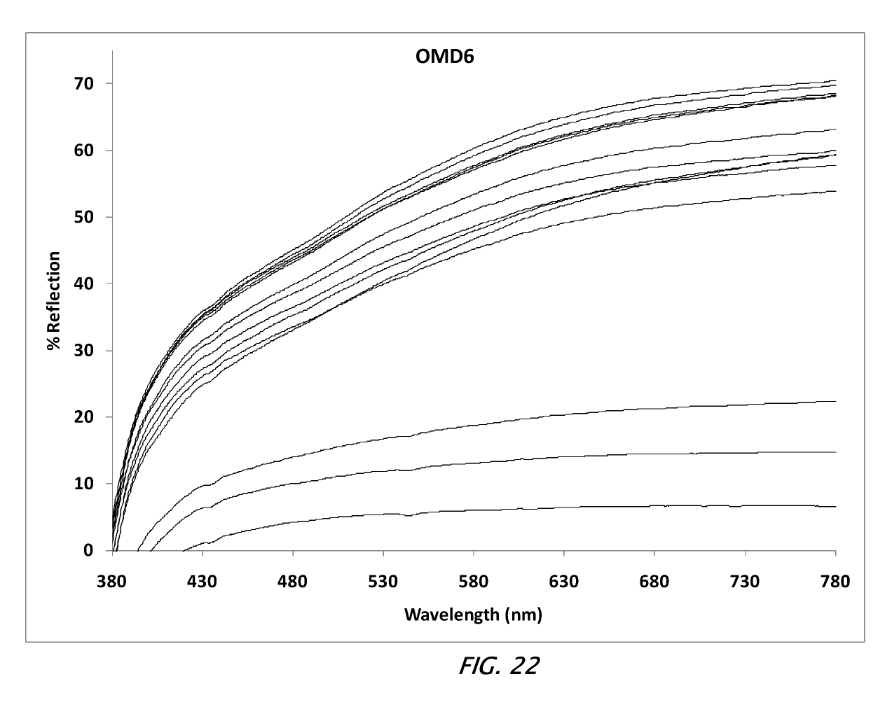

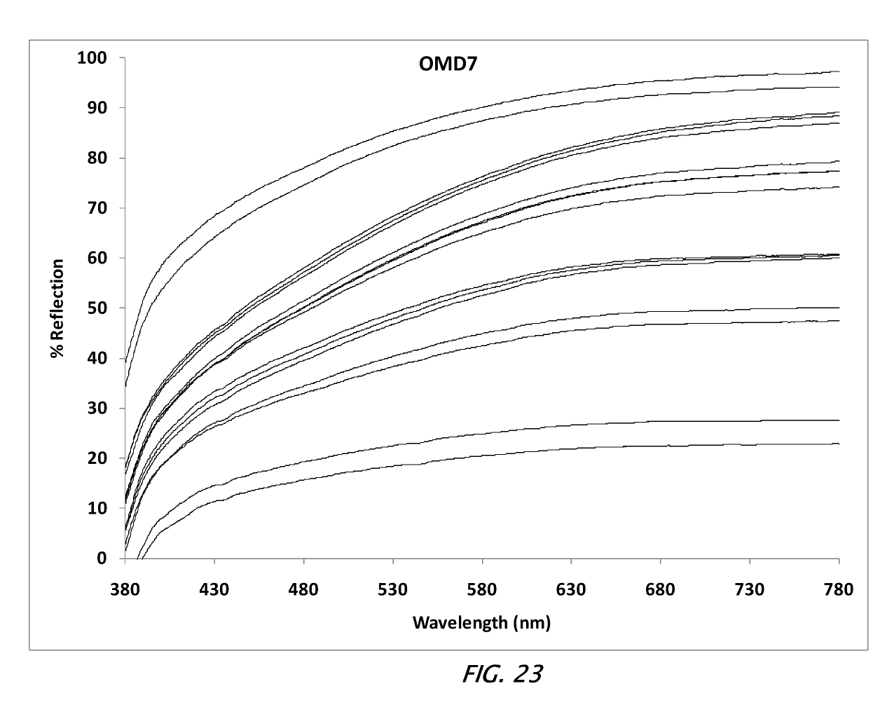

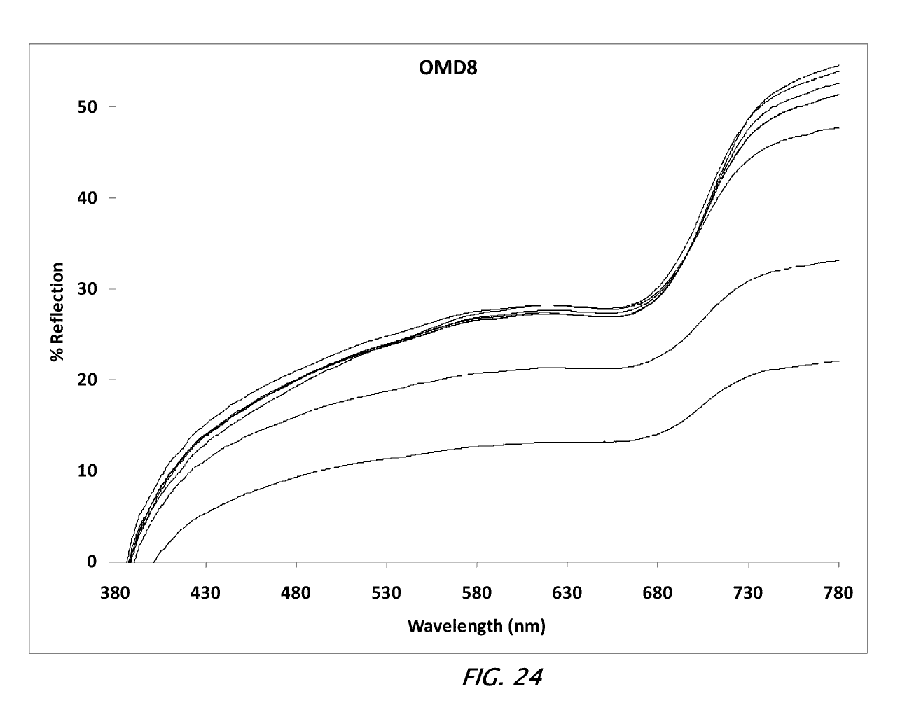

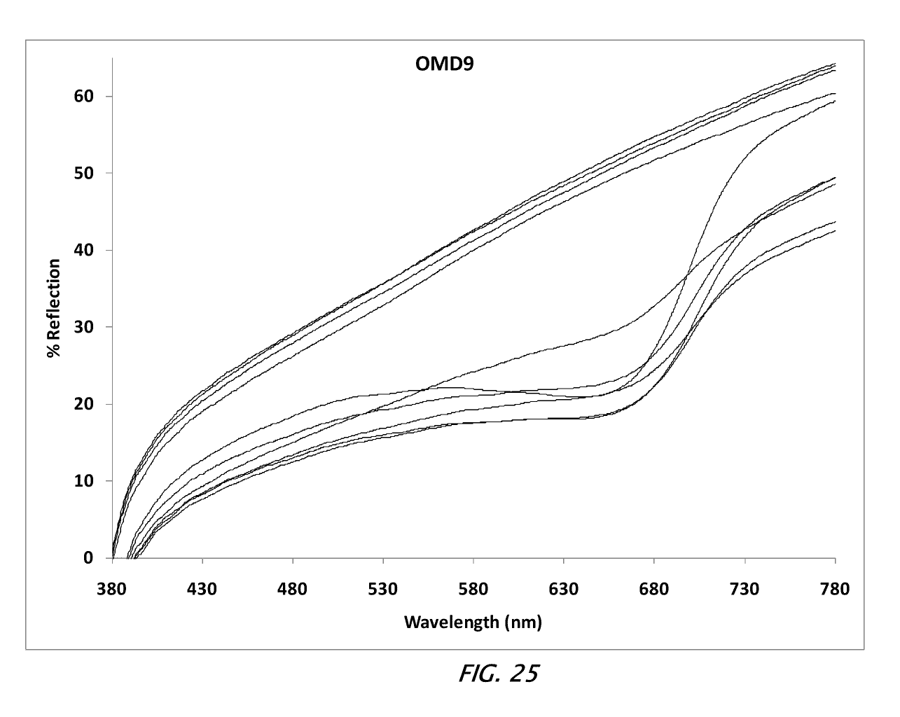

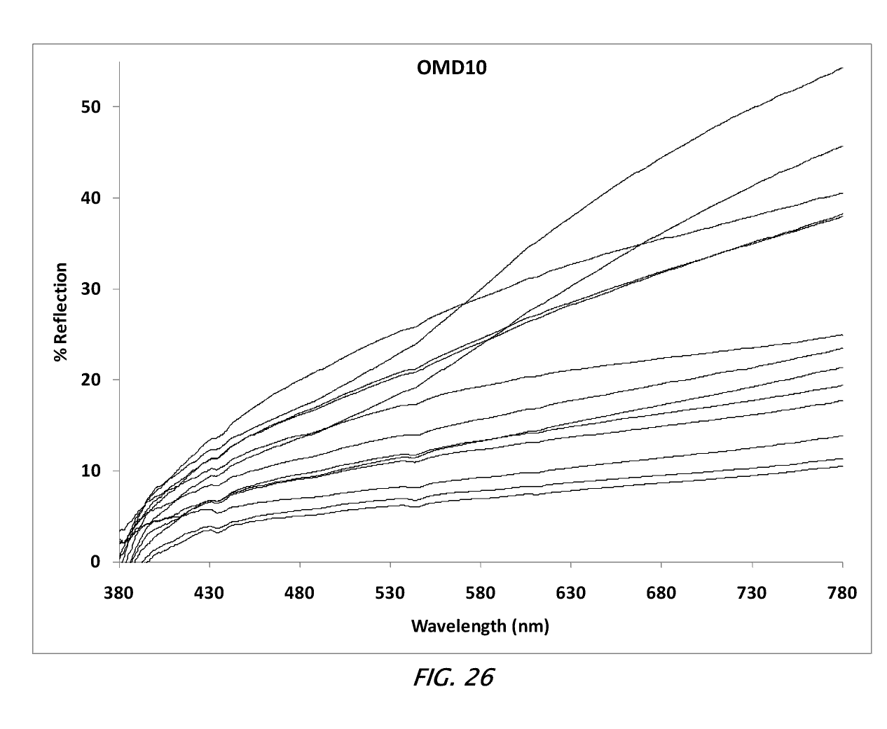

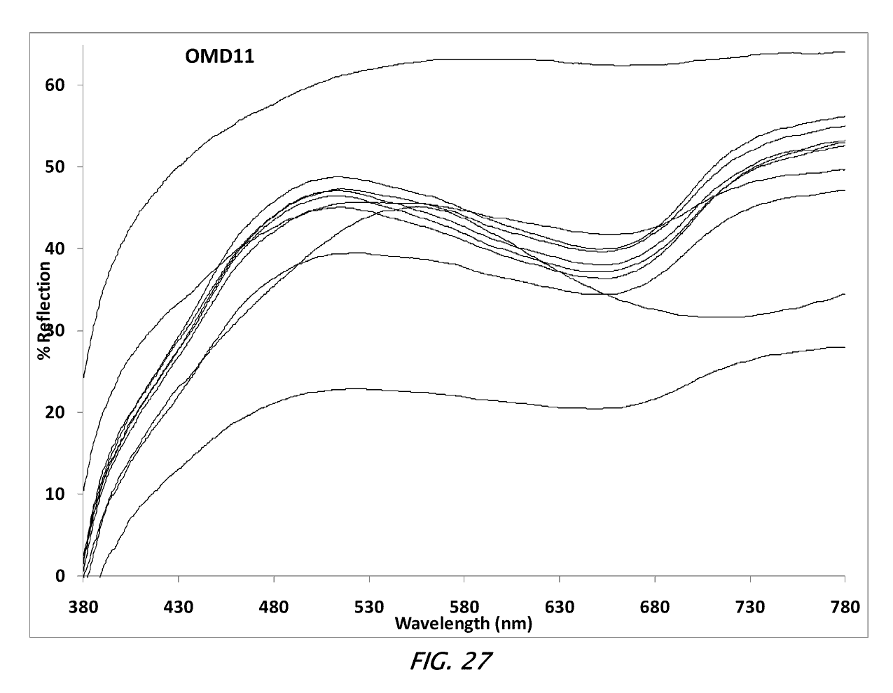

Color rendering refers to the accuracy with which colors are rendered by one illuminant relative to a reference illuminant. Color Rendering Index (CRI) is an indication of how well the illuminant is matched to the reference illuminant, with a CRI≡100 being a perfect match of the illuminant to the reference illuminant. For example, in FIG. 1, the CRI of the second source illuminant 38 and filter 42 could be calculated relative to the unfiltered illuminant 26 (which would act as the reference illuminant), or could be calculated relative to a theoretical reference illuminant (e.g., Standard A). CRI relates to color difference such that 4.6 CRI units are about equivalent to DE=1 color difference unit. In this way, just-perceptible changes in CRI occur between the following points: 100, 95.4, 90.8, 86.2, 81.6, and so on (even below zero in some instances). CRI can be determined by calculating color difference between the illuminant and the reference illuminant and applying adaptation models to determine the appropriate perceived CRI. CRI can be determined using CIE 13.3 and/or a modified version of CIE 13.3. Modifications for one example of a modified version of CIE 13.3 are described in Table 1. The standard CIE 13.3 method generally uses reflection spectra for 8 colors in the Munsell 8 color reference. The “Old Master Drawing” (OMD) reflection spectra includes reflection spectra for 120 colors selected in 11 old master drawings created, for example, during the period 1500-1900 CE that were selected as apparently representative of many old master drawings from the period and other time periods before and after. The Old Master Drawing reflection spectra referred to in this disclosure are depicted below in FIGS. 17-27. Other reflection spectra can be generated or obtained for other types works of art and/or other time (e.g., oil paintings, watercolor paintings, impressionist paintings).

TABLE 1
Modified Color Rendering Methodology

| | Standard CIE13.3 | |
|---|---|---|
| | Method | Modified Methods |
| Color Difference | U*V*W* | DE00 |
| Adaptation | von Kries | CIE109.2 |
| Standard Object basis | Munsell 8 color | Old Master Drawing |
| | reference | Reflection spectra |

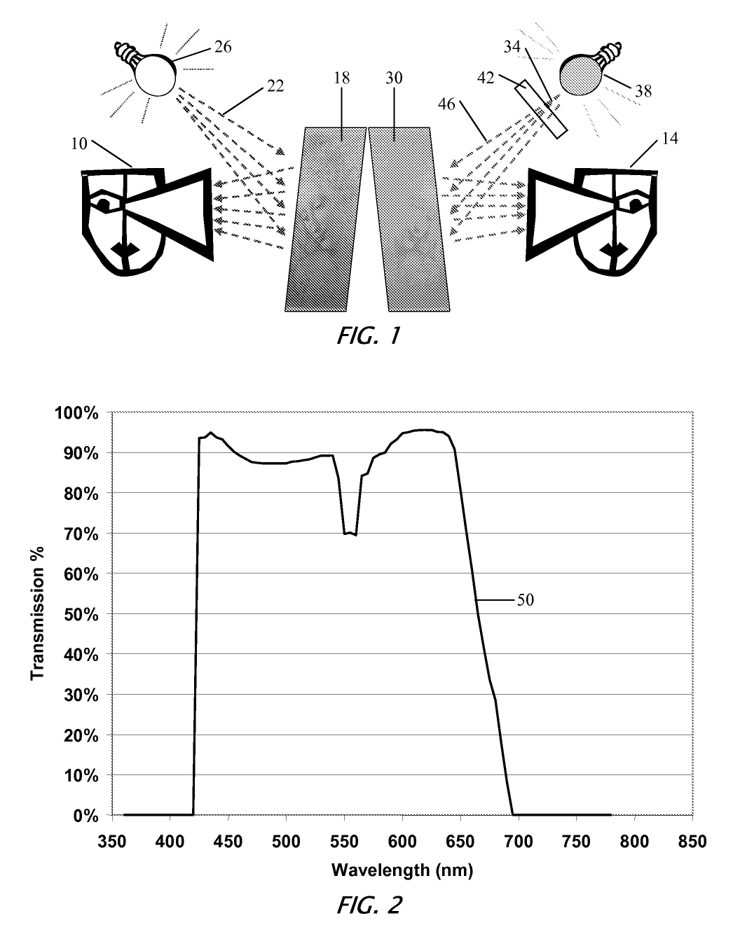

FIG. 2 depicts one example of a theoretical customized spectral profile 50 developed (optimized) to have desirable illumination characteristics. Some of the following characteristics of the customized spectral profile 50 may be described in this disclosure without reference to a reference illuminant or source illuminant; it will be understood by those of ordinary skill of the art, however, that certain of the characteristics described may require or be best understood in context of a filter having customized spectral profile 50 and/or an illuminant configured (e.g., by way of one or more filter layers) to incorporate customized spectral profile 50, and/or may by nature be defined relative to an unfiltered illuminant. Theoretical customized spectral profile 50 shown is configured to have a power transmission of about 55% relative to an unfiltered incandescent source illuminant having a color temperature of 3000K (e.g., Sylvania 58562). That is, for example, if a filter were constructed to have the customized spectral profile of FIG. 2 and the filter were optically coupled to the source illuminant, then 55% of the power of the light from the source illuminant would be transmitted through the filter. Additionally, customized spectral profile 50 is configured to have a lumens/per watt efficiency of greater than about 170% (e.g., greater than, less than, or equal to, about any of 180%, 183%, 185%, 190%, 191%), and to have a CRI of greater than about 90 (e.g., greater than, less than, or equal to, about any of 95, 98, 98.4, 98.9, 99, 99.2) relative to a reference illuminant.

In some embodiments, the power transmission of a customized spectral profile, filter, or illuminant is determined as a relative power transmission (e.g., power relative to the power of equal-luminosity light from a reference illuminant). For example, if a filter is configured to have a relative power transmission of 55% is optically coupled to a source illuminant (e.g., Sylvania 58562) such that light from the source illuminant is filtered, then the filtered light will have a power that is approximately 55% of the power of unfiltered light from a reference illuminant having the same luminosity (e.g., an unfiltered Sylvania 58562, or any other suitable reference illuminant). In some embodiments, this relative power transmission can be determined as follows: (a) determine total power of filtered light (Filtered Power) by multiplying transmission spectrum of the filter by the spectrum of the source illuminant, and integrating under this product curve; (b) determine the total power of the reference illuminant (Reference Power) by integrating under the spectrum of the reference illuminant; (c) determine the luminosity of the filtered light (Filtered Luminosity) by multiplying the transmission spectrum of the filter by the spectrum of the source illuminant and by the photopic function, and then integrating under the product spectrum; (d) determine the luminosity of the reference spectrum (Reference Luminosity) by multiplying the spectrum of the reference illuminant by the photopic function, and integrating the product spectrum; and (e) determine the relative total power by dividing the product of Filtered Power and Reference Luminosity by the product of Reference Power and Reference Luminosity).

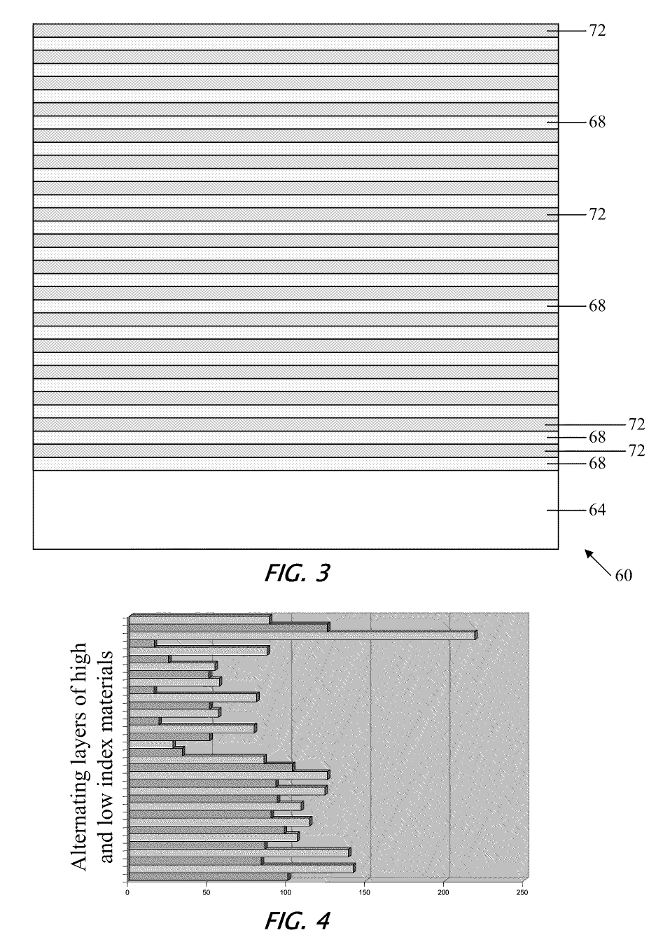

FIG. 3 depicts a portion of an embodiment of a filter configuration. In the embodiment shown, filter 60 comprises a substrate 64, a plurality of first filter layers 68, and a plurality of second filter layers 72. First filter layers 68 and second filter layers 72 can be, and are shown, coupled in an alternating configuration (e.g., first filter layer 68/second filter layer 72/first filter layer 68/second filter layer 72). Although first filter layers 68 and second filter layers 72 are depicted with equal thicknesses, in practice, at least a portion of first and second filter layers 68 and 72 may each have a different thickness, such as, for example, any suitable thickness equal to or between any range between about 5 nanometers (nm) and about 500 nm. As such, it should be appreciated that the relative thicknesses of the substrate, first filter layers, and second filter layers are not necessarily shown in proper proportion for all embodiments of the present filters. Filter 60 can be configured to have any suitable number of first filter layers and/or second filter layers, such as, for example, at least or more than 10, more than 15, or more (e.g., 10, 11, 12, 13, 14, 15, 16, 17, 18, 19, 20, or more first filter layers and/or an equal or unequal number of second filter layers).

In the embodiment shown, first filter layers 68 comprise a first material, and second filter layers 72 comprise a second material. The first material can, for example, have a relatively higher index of refraction than the second material; or the second material can have a relatively higher index of refraction that the first material. In the embodiment shown, a first filter layer is in direct contact with substrate 64. In the embodiment shown, the filter is further configured such that if optically coupled to an appropriate source illuminant (e.g., an active or “on” source illuminant) such that light is incident on the filter from the source illuminant (e.g., at an angle-of-incidence of 90 degrees, though allowances or changes can be made or provided for other angles of incidence), the filter will have a lumens/watt efficiency of more than about 170% and a color rendering index (CRI) of more than about 90, where the lumens/watt efficiency and CRI are determined relative to an unfiltered reference illuminant. In some embodiments, the filter can be further configured to have a power transmission of between about 50% and about 60%, between about 54% and about 56%, or of about 55%. As mentioned above, the reference illuminant can be a reference standard (e.g., Standard A, Standard D65, Standard F7), or can be an actual (e.g., physical or tangible) illuminant, such as a Sylvania blackbody 58562 bulb (e.g., having a color temperature of about 3000K), one or more LEDs, sunlight, a fluorescent illuminant, a candle, or the like.

Various embodiments of the filters described herein can comprise any suitable materials. For example, substrate 64 can comprise glass such as borosilicate glass. One example of a suitable substrate (at least for certain filter layer materials and configurations described herein is 8511 Glass manufactured by the Corning Corporation, U.S.A. Table 2 illustrates the composition of 8511 Glass. In some embodiments, the substrate (e.g., 8511 Glass) the substrate is configured to transmit light having a wavelength above about 400 nanometers (nm) and to substantially block light having a wavelength below about 400 nm. By way of further examples, each of the first filter layers can comprise Niobium (Nb), such as, for example, Niobium Pentoxide (Nb₂O₅); and/or each of the second filter layers can comprise Silicone (Si), such as, for example, Silicone Oxide (Si0₂). First and second filter layers 68 and 72 can be deposited or configured in any suitable way, such as, for example, by magnetron-sputtering techniques, or by any other method or technique.

TABLE 2
8511 Glass Composition

| | |
|---|---|
| SiO₂ | 59.7 ± 0.30 |
| Al₂O₃ | 11.2 ± 0.20 |
| B₂O₃ | 17.4 ± 0.20 |
| Li₂O | 2.00 ± 0.10 |
| Na₂O | 4.48 ± 0.15 |
| K₂O | 3.30 ± 0.15 |
| CuO | 0.39 ± 0.03 |
| SnO₂ | 0.63 ± 0.03 |
| Br | 0.31 ± 0.01 |
| Cl | 0.077 ± 0.01 |

Various embodiments of the present filters and illuminants can be configured to have a customized spectral profile of which at least portions are substantially similar to theoretical customized spectral profile 50. For example, some embodiments of the present filters can be configured such that if light is incident on the filter from a source illuminant, the filter will: (a) block at least 95% of light having a wavelength below about 400 nanometers; (b) block at least 95% of light having a wavelength above about 700 nm; (c) block less than 20% of light having a wavelength between 450 nm and 630 nm and between 530 nm and 570 nm; and/or (d) block between about 25% and about 35% of at least one wavelength of light having a wavelength between about 530 nm and about 570 nm. By way of another example, such embodiments can be further configured such that if light is incident on the filter from a source illuminant, the filter will block between about 25% and about 35% of at least one wavelength of light having a wavelength between about 545 nm and about 555 nm. By way of yet another example, in such embodiments the reference illuminant can be an incandescent lamp having a color temperature of about 3000K (e.g., Standard A, Sylvania 58562), and the filter can be further configured such that if light is incident on the filter from an incandescent lamp (source illuminant) having a color temperature of about 3000K (e.g., a Sylvania 58533 illuminant), the filter will block between about 25% and about 35% (e.g., about 30%) of light having a wavelength between about 545 nm and about 555 nm.

Some embodiments of the present filters can be described as photopic filters configured such that if light is incident on the filter from a source illuminant, the filter will block substantially all non-visible light, and will have a lumens/watt efficiency of more than about 170% and a color rendering index of more than about 90, relative to an unfiltered incandescent lamp having a color temperature of about 3000K.

Various embodiments of the present illuminants can also be configured to have a customized spectral profile substantially similar to theoretical customized spectral profile 50 of FIG. 2. For example, in some embodiments, an illuminant has a customized spectral profile and comprises: one or more light sources (e.g., an incandescent lamp or light bulb, one or more LEDs, one or more fluorescent lamps or bulbs, or any other suitable illuminant); a plurality of first filter layers comprising a first material; and a plurality of second filter layers comprising a second material; where at least a portion of the first filter layers and at least a portion of the second filter layers are coupled in an alternating configuration; and where the illuminant is configured to have a lumens/watt efficiency of more than about 170% and a color rendering index (CRI) of more than about 90, relative to an unfiltered reference illuminant that comprises an incandescent lamp having a color temperature of about 3000K. In some embodiments, the one or more light sources comprise three or more light-emitting diodes (LEDs). In some embodiments, the one or more light sources comprise more than three LEDs (e.g., six LEDs). In some embodiments, the one or more light sources comprise a substrate (e.g., a glass bulb portion), and one of the first filter layers is in direct contact with the substrate. In other embodiments, the first filter layers and second filter layers are spaced apart from the one or more light sources (e.g., where the illuminant comprises a frame or the like that couples, e.g., removably or non-removably, a filter and the one or more light sources.

Any of the various filters and/or illuminants can be configured to have a customized spectral profile and/or other characteristics that are substantially similar to the experimental customized spectral profile and/or other characteristics of the prototype filter described below.

### Prototype Filter

A prototype filter was designed and manufactured to have a customized spectral profile substantially similar to theoretical customized spectral profile 50 of FIG. 2. The prototype filter was designed for a source illuminant (spectrum profile of) Sylvania 58533 lamp, relative to a reference illuminant (spectral profile of) Sylvania 58562. Relative characteristics of the prototype filter are thus given for light from a Sylvania 58533 (source illuminant) filtered through the prototype filter, relative to an unfiltered Sylvania 58562 illuminant (reference illuminant). It should be understood that other embodiments of the present filters can be designed to have a customized spectral profile that yields similar characteristics (e.g., CRI, lumens/watt efficiency, power transmission, UV-cutoff, visible-IR cutoff, and/or selective blocking of damaging wavelengths) for any combination of one or more source illuminants and one or more reference illuminants. For example, in one embodiment, the source illuminant can be a Sylvania 58533 illuminant and the reference illuminant can be a Standard A illuminant. In another embodiment, the source or reference illuminant could be sunlight, as in window covering to protect artwork within a room. In other embodiments, the reference could be candlelight, limelight, arc light or mantle-light.

The prototype filter was configured to have a customized spectral profile substantially similar to customized spectral profile 50, as described in more detail below. The prototype filter was physically configured similarly to filter 60 in FIG. 3. Specifically, the prototype filter comprised: a substrate 64, seventeen first filter layers 68, and seventeen second filter layers 72. Substrate 64 comprised 8511 Glass, first filter layers 68 comprised Niobium Pentoxide (Nb₂O₅), and second filter layers 72 comprised Silicone Oxide (Si0₂). First filter layers 68 and second filter layers 72 were deposited by magnetron-sputtering techniques using a Leybold HELIOS coater, available from Leybold Optics, Alzenau, Germany, and possibly also available from Leybold Optics USA, Cary, N.C., U.S.A. First filter layers and second filter layers were deposited in the layer thicknesses listed in Table 3 and illustrated in FIG. 4. The filter layer numbered #1 in Table 3 was on or against (e.g., in direct contact with) the substrate (e.g., substrate 64).

TABLE 3
Prototype Filter Layer Configuration

| | | Layer |
|---|---|---|
| Layer # | Material | Thickness (nm) |
| 1 | Nb₂O₅ | 100.30 |
| 2 | SiO₂ | 141.54 |
| 3 | Nb₂O₅ | 83.49 |
| 4 | SiO₂ | 138.55 |
| 5 | Nb₂O₅ | 85.69 |
| 6 | SiO₂ | 106.14 |
| 7 | Nb₂O₅ | 97.97 |
| 8 | SiO₂ | 114.00 |
| 9 | Nb₂O₅ | 89.70 |
| 10 | SiO₂ | 108.74 |
| 11 | Nb₂O₅ | 93.66 |
| 12 | SiO₂ | 123.82 |
| 13 | Nb₂O₅ | 92.60 |
| 14 | SiO₂ | 125.31 |
| 15 | Nb₂O₅ | 103.21 |
| 16 | SiO₂ | 85.10 |
| 17 | Nb₂O₅ | 33.45 |
| 18 | SiO₂ | 27.51 |
| 19 | Nb₂O₅ | 50.86 |
| 20 | SiO₂ | 79.04 |
| 21 | Nb₂O₅ | 18.61 |
| 22 | SiO₂ | 56.50 |
| 23 | Nb₂O₅ | 50.65 |
| 24 | SiO₂ | 80.50 |
| 25 | Nb₂O₅ | 15.57 |
| 26 | SiO₂ | 56.97 |
| 27 | Nb₂O₅ | 50.10 |
| 28 | SiO₂ | 54.14 |
| 29 | Nb₂O₅ | 24.68 |
| 30 | SiO₂ | 87.25 |
| 31 | Nb₂O₅ | 15.72 |
| 32 | SiO₂ | 218.51 |
| 33 | Nb₂O₅ | 125.27 |
| 34 | SiO₂ | 88.60 |

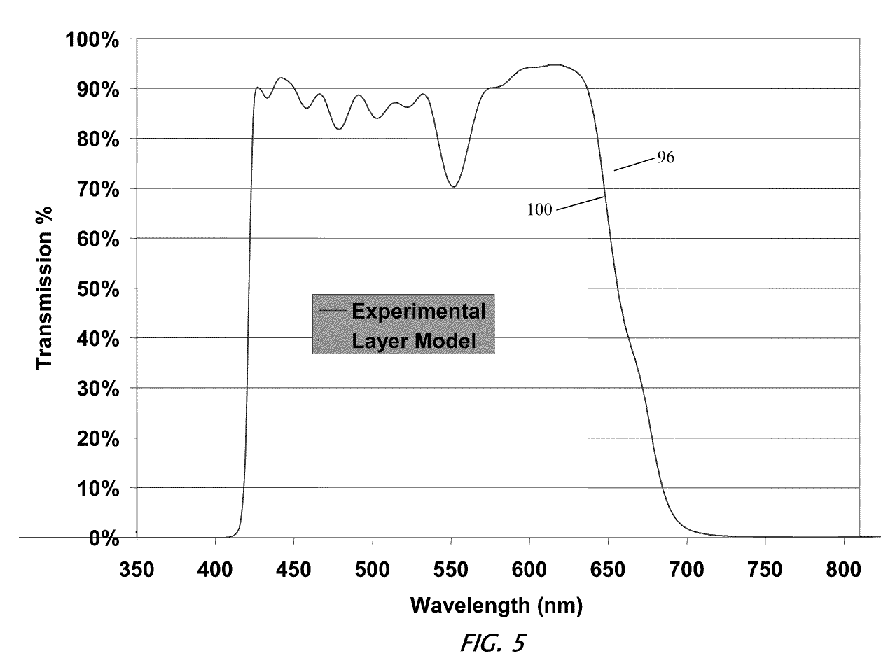

Referring now to FIG. 5, a layer model was used to generate an expected layer-model customized spectral profile 96 (dotted line) of the layer configuration of the prototype filter which showed that the layer-model customized spectral profile 96 is substantially similar to theoretical customized spectral profile 50 of FIG. 2. Filters of this type may be modeled by commercial software applications such as TFCALC from Software Spectra, Inc., of Portland, Oreg., USA. Experimental data was also collected using a UV-visible spectrometer or spectrograph to generate an experimental customized spectral profile 100 (darker, solid line) of the prototype filter. As shown in FIG. 5, layer-model customized spectral profile 96 is substantially similar to experimental customized spectral profile 100. Similarly, layer-model customized spectral profile 96 and experimental customized spectral profile 100 are each substantially similar to theoretical customized spectral profile 50 of FIG. 2. For example, each of customized spectral profiles 50, 96, and 100 includes a dip at wavelengths just above 550 nm at which about 70% of light is substantially blocked.

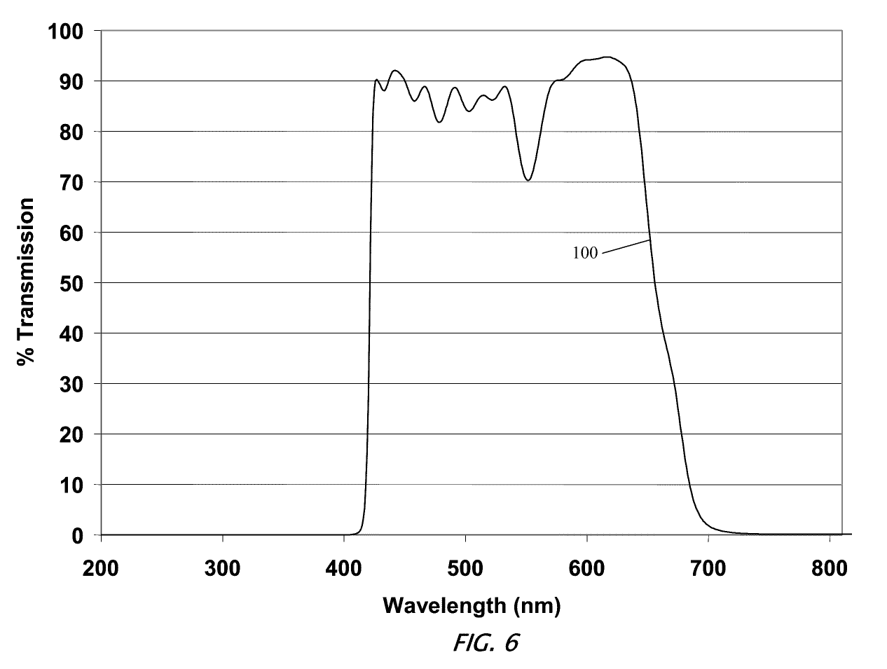

FIG. 6 depicts only experimental customized spectral profile 100 of the prototype filter. Spectral profile 100 is configured such that if light is incident on the filter from a source illuminant (Sylvania 58533), the filter will: (a) block at least 95% of light having a wavelength below about 400 nanometers; (b) block at least 95% of light having a wavelength above about 700 nm; and (c) block less than 20% of light having a wavelength between 450 nm and 630 nm and between 530 nm and 570 nm. As shown, the filter is further configured such that spectral profile 100 includes a dip or relative minimum for wavelengths of light between about 530 nm and about 570 nm, and more particularly, between about 545 nm and about 555 nm. At this dip, the prototype filter is configured to block between about 25% and about 35% (e.g., about 30%) of at least one wavelength of light having a wavelength. More particularly, the prototype filter is configured such that for an unfiltered reference illuminant (Sylvania 58562) that is an incandescent lamp having a color temperature of about 3000K, if light is incident on the prototype filter from a source lamp (Sylvania 58533, though similar results can typically be expected from other incandescent illuminants having a color temperature of about 3000K), the prototype filter will block between about 25% and about 35% (between about 25% and about 30%) of light having a wavelength between about 445 nm and about 555 nm. It is believed that this dip or relative minimum contributes to the improved color rendering properties of the prototype filter.

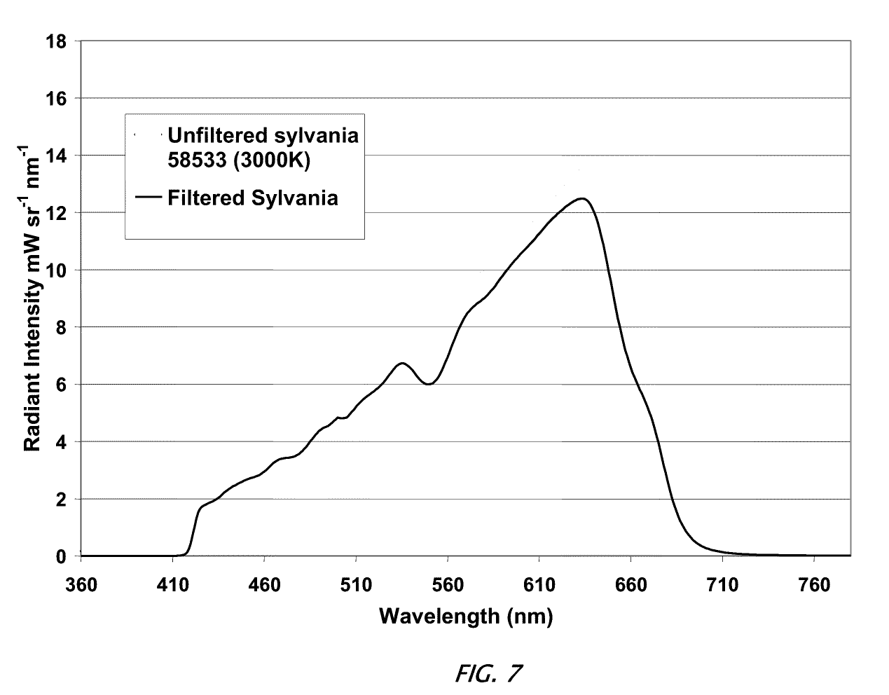

FIG. 7 illustrates radiant intensity profiles for an unfiltered (dotted line) Sylvania 58533 source illuminant and for a filtered (with the prototype filter; darker, solid line) Sylvania 58533 source illuminant. Similarly to theoretical customized spectral profile 50, the prototype filter is configured to have a relative power transmission (relative to a Sylvania 58562 reference illuminant at equal luminance) between about 50% and about 60%, (e.g., between about 54% and about 56%, and/or equal to about 55%). The prototype filter is also configured to have a CRI of more than 95 for the same reference and source illuminants. In particular, CRIs of the layer model and actual prototype filter were calculated using a modified CIE 13.3 method using color difference formula DE00 and using the CIE 109.2 Nayatani adaptation model for each of the Munsell 8 and OMD reflection spectra. Lumens/watt efficiency was also calculated for the layer model and actual prototype filter. Calculated CRIs and lumens/watt efficiency for each of the layer model and actual prototype filters are listed in Table 4.

TABLE 4
Layer Model and Experimental Filter Properties

| | CRI (DE00-CIE109.2- | CRI (DE00-CIE109.2- | Lumens/Watt |
|---|---|---|---|
| | OMD) | Munsell {8}) | Efficiency |
| Model | 99.2 | 98.4 | 183% |
| Actual | 98.9 | 98.0 | 191% |
| Filter | | | |

Color rendering was also evaluated using human subjects for the prototype filter using each of the Farnsworth D15 and L'Anthony D15 color confusion indices (CCIs) for filtered incandescent light from a Sylvania 58533 (filtered through the prototype filter) relative to unfiltered incandescent light from a Sylvania 58562 lamp. The CCIs determined from these evaluations are listed in Table 5. As shown in Table 5, the prototype filter performed very well in that the CCIs for filtered light were very close to the CCIs for unfiltered light. Various other embodiments of the present filters and illuminants can be configured to have similar characteristics.

TABLE 5
Color Confusion Index

| | Farnsworth D15 CCI | | L'Anthony D15 CCI | |
|---|---|---|---|---|
| | Filtered | Unfiltered | Filtered | Unfiltered |
| Prototype | 1.02 ± 0.06 | 1.05 ± 0.09 | 1.05 ± 0.09 | 1.14 ± 0.34 |
| (55% P) | | | | |
| (sample = | | | | |
| 11 people) | | | | |

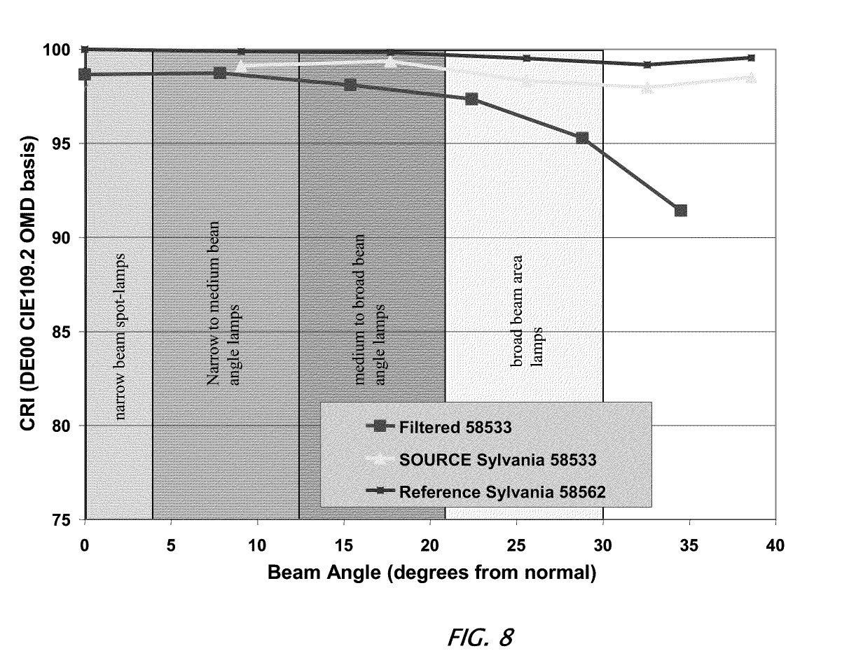

Referring now to FIG. 8, beam-angle dependence of CRI was also determined for a Sylvania 58562 reference illuminant, an unfiltered Sylvania 58533 source illuminant, and for a filtered (with the prototype filter) Sylvania 58533 source illuminant. The CRI for beam angle dependence was calculated using the modified CIE 13.3 method using the DE00 color-difference formula, the CIE 109.2 Nayatani adaptation model, and the OMD reflection spectra. The beam angle for the plot is zeroed at an incident beam angle of 90 degrees (normal to the plane of the prototype filter) and progresses through angles that deviate from normal (90 degrees) by up to nearly 35 degrees (e.g., incident beam angles as small as 55 degrees relative to the plane of the prototype filter). As shown, the prototype filter maintains a CRI above 95 at beam angle deviations of up to approximately 28 degrees, and maintains a CRI above 90 out to beam angle deviations of at least up to approximately 34 degrees. As shown, some portion of beam-angle dependence for CRI (CRI deviation) may be due to the beam-angle dependence of the source illuminant. Various other embodiments of the present filters can be configure to have similar levels or ranges of beam angle dependence (or independence).

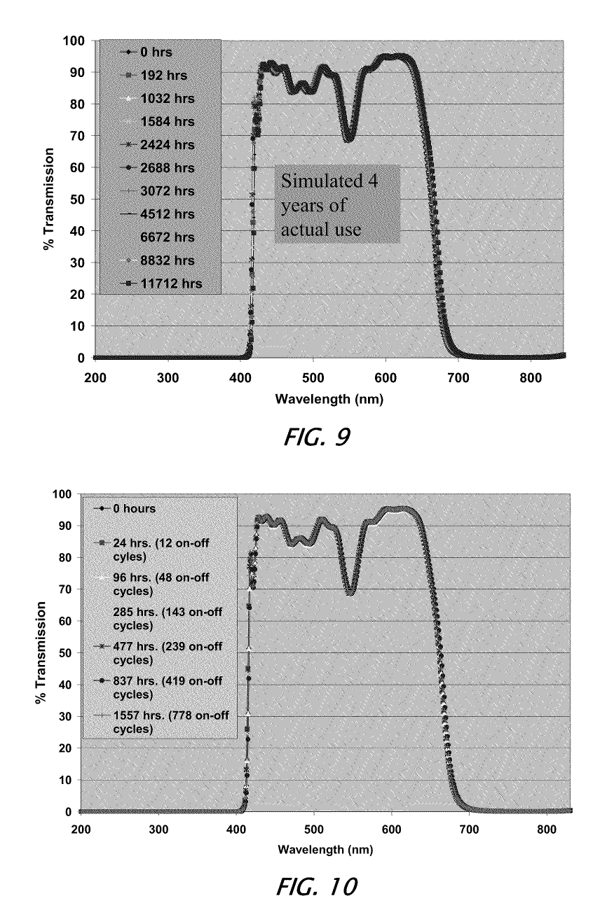

Referring now to FIGS. 9 and 10, the prototype filter has also been tested for stability under extended operating conditions, such as, for example, continued exposure to light and heat (thermal energy) from a source illuminant. FIG. 9 depicts the customized spectral profile of the prototype filter during simulated ageing testing. In particular, the prototype filter was placed within 12 inches of a Sylvania 58533 source illuminant for extended periods of time and the customized spectral profile experimentally determined periodically at various periods of continued illumination simulating up to 4 years of continuous use (based on approximately 8 hours of use per day). Further, no delamination of layers was observed for the prototype filter. As shown, the experimental profile of the prototype filter remained substantially stable for the entire period of accelerated ageing. This stability can be characterized in a number of ways, such as, for example, less than 5% change (e.g., in transmission percentage at individual wavelengths or wavelength regions, in lateral shift of transmission percentage from one wavelength to another, and/or on average in one or more directions across the spectrum) for up to 1, 2, 3, 4, or more years of use (e.g., for a period of hours equal to the sum of hours, e.g., 8, per day of expected illumination for the number of days of expected illumination in a period of time, e.g., years or months). Various other embodiments of the present filters and/or illuminants can be configured to have similar stability characteristics.

FIG. 10 depicts the customized spectral profile of the prototype filter during thermo-mechanical stress testing. In particular, the prototype filter was placed within 12 inches of a Sylvania 58533 source illuminant (lamp) and the lamp cycled on and off, in which each on/off cycle included one hour during which the lamp was on and one hour during which the lamp was off, and where during the on portion of an on/off cycle the lamp typically reached a maximum temperature of at least 180 degrees Celsius. In this way, each cycle simulated the thermo-mechanical stresses for a day of use of a filter (e.g., with the lamp being turned on once such that the lamp and filter heat up, and with the lamp being turned off once such that the lamp and filter cool of). The customized spectral profile of the prototype filter was experimentally determined periodically at various periods. As shown, the experimental profile of the prototype filter remained substantially stable for the entire period of accelerated thermo-mechanical stress testing. Further, no delamination of layers was observed for the prototype filter. As such, it can be seen that the prototype filter is configured such that the filtering and mechanical properties of the filter are substantially stable through at least 200 (and up to over 750) on/off cycles in which the filter is disposed within 12 inches of an incandescent lamp, where each on/off cycle includes one hour during which the lamp is on and one hour during which the lamp is off, and where during the on portion of an on/off cycle the lamp reaches a maximum temperature of at least 180 degrees Celsius. This stability can be further characterized in a number of ways, such as, for example, less than 5% change (e.g., in transmission percentage at individual wavelengths or wavelength regions, in lateral shift of transmission percentage from one wavelength to another, and/or on average in one or more directions across the spectrum) for up to 100, 200, 300, 400, 500, 750 or more on/off cycles. Various other embodiments of the present filters and/or illuminants can be configured to have similar stability characteristics.

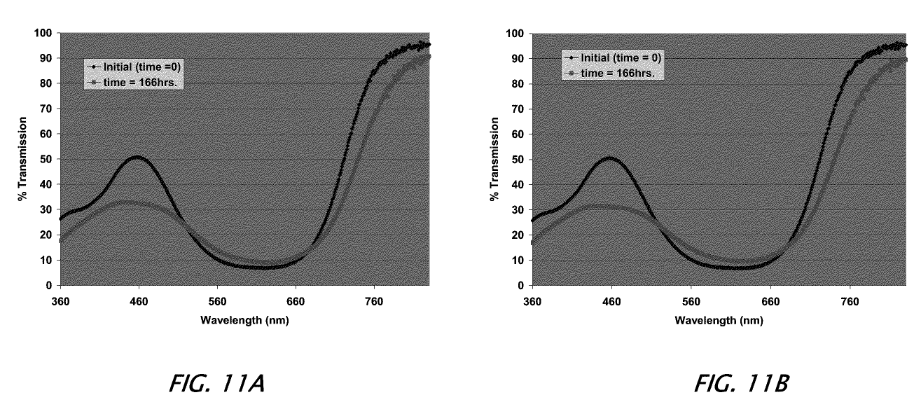

Referring now to FIGS. 11-13, testing was also performed on a comparison filter (an Optivex™ filter, manufactured by Applied Coatings, Inc., Rochester, N.Y., U.S.A.) for comparison to the prototype filter. FIGS. 11A and 11B depict reflection spectra curves for the prototype filter and a comparison filter, respectively, at 0 hours and 166 hours for the “Blue Wool 2” color fastness standard pigment. The Blue Wool 2 test sample was purchased from SDC Enterprises, Ltd. UK, and was of the type that may, for example, be used in or in conjunction with the ISO 105-B series of color-fastness tests. Specifically, two samples Blue Wool 2 pigment were illuminated using source illuminant Sylvania 58533 lamps (one filtered with the comparison filter and one filtered with the prototype filter) for a period of 166 hours, and reflection spectra were obtained for each sample at 0 hours and at 166 hours. FIG. 11A depicts the 0 hour reflection spectrum (darker line) and 166 hour reflection spectrum (lighter line) for the sample illuminated with light filtered through the prototype filter. FIG. 11B depicts the 0 hour reflection spectrum (darker line) and 166 hour reflection spectrum (lighter line) for the sample illuminated with light filtered through the comparison filter. The color difference between 0 hours and 166 hours for each sample using the DE00 color difference formula. The color difference for the prototype filter was calculated as 14.32±0.18, and the color difference for the comparison filter was calculated as 15.73±0.05. The prototype filter thus protected the pigment better than the comparison filter, resulting in a lower color change in the pigment over the 166 hour period.

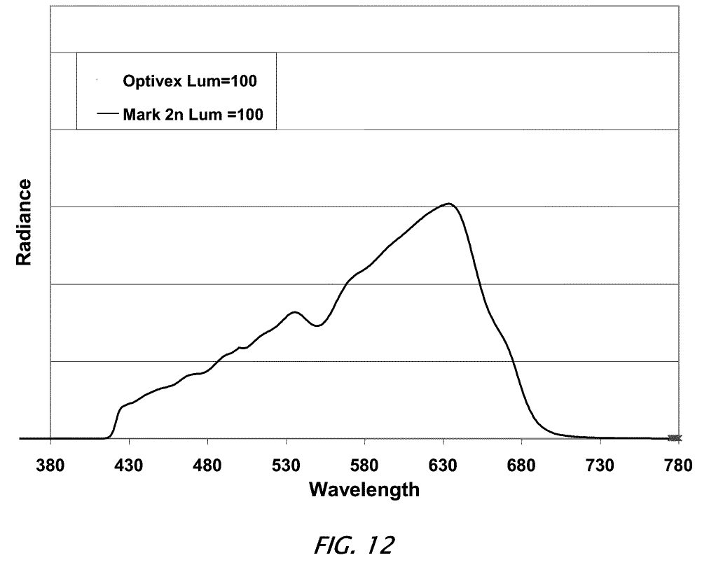

FIG. 12 depicts equal-luminosity (100 lumens) radiance profiles for each of the prototype filter and the comparison filter. As shown, the prototype filter is drastically better at blocking wavelengths of light above about 640 nm (including infrared (IR) wavelengths). Various other embodiments of the present filters and illuminants can be configured to have similar characteristics.

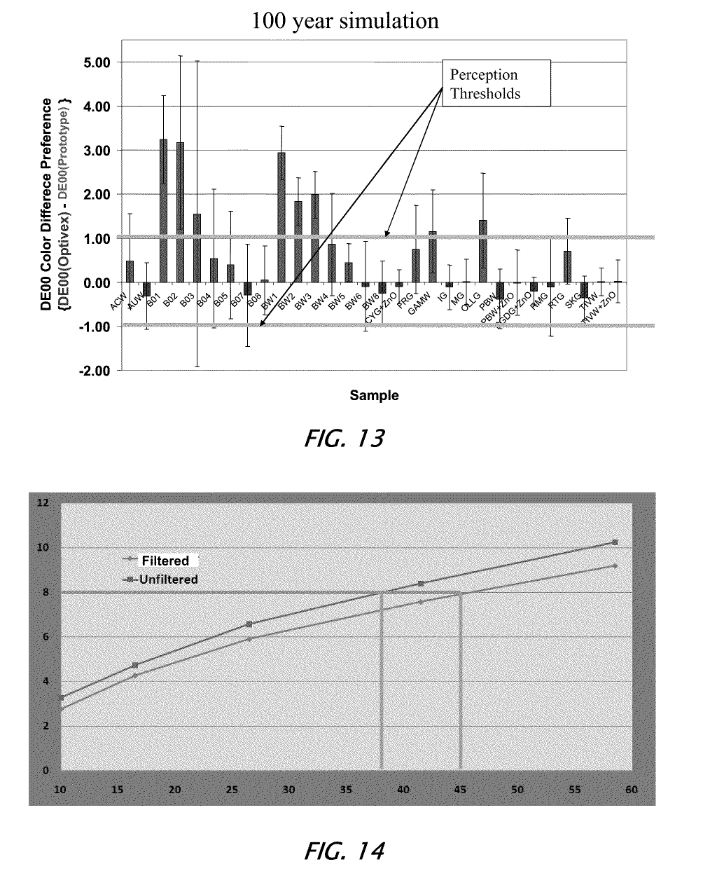

FIG. 13 depicts color difference comparison (and relative preference) between the prototype filter and the comparison filter for a variety of pigments after a 100-year ageing simulation. This data was collected by irradiating various pigmented samples in enclosures where one enclosure was solely irradiation by light filtered by the prototype filter, and the other enclosure was solely irradiated by similar light filtered through the comparison filter, with luminosity of each enclosure maintained within ±5% of each another. Expected color changes were calculated for each filter and each pigment using the DE00 color-difference formula, and for each pigment, the expected color difference for the prototype filter was subtracted from the expected color difference for the comparison filter. Positive bars (above zero) indicate the pigments for which the prototype filter is expected to better-protect individual pigments. Negative bars (bars below zero) indicate the pigments for which the comparison filter is expected to better-protect individual pigments. The perception thresholds at 1.00 and ±1.00 indicate a relative color difference with an absolute value above 1.00 (e.g., a perceptible color difference). That is, where the positive bars exceed the perception threshold, the prototype filter is expected to better-protect the respective pigment to a perceptible degree relative to the comparison filter. As shown, the prototype filter outperforms the comparison filter to a perceptible degree for a number of the tested pigments. Further, even where the comparison filter outperforms the prototype filter, it is not to a perceptible degree, and does not exceed experimental error. Various other embodiments of the present filters and illuminants can be configured to have similar characteristics.

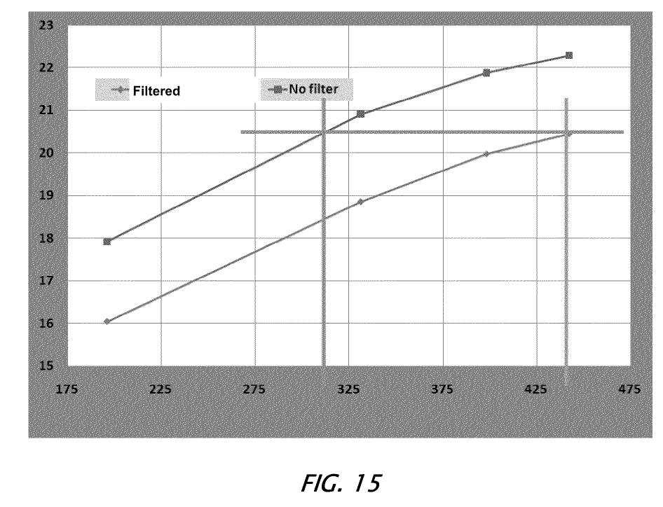

Referring now to FIGS. 14 and 15, experiments were performed for a “Blue Wool 1” standard pigment to determine the protection of the prototype filter relative to unfiltered light from a 5600 lux incandescent source illuminant. The x-axis of each plot indicates hours of illumination, and the y-axis of each plot indicates the color change calculated with the DE00 color-difference formula. As shown in FIG. 14, when the source illuminant is filtered with the prototype filter, a color change equivalent to a color difference of eight (8) takes about 20% (7 hours) longer than for the unfiltered source illuminant. As shown in FIG. 15, when the source illuminant is filtered with the prototype filter, a color change equivalent to a color difference of about 20.5 takes over 40% (over about 120 hours) longer than for the unfiltered source illuminant. FIGS. 14 and 15 suggest that the prototype filter provides some degree of protection from fading or color change for a pigment that is “fresh” (e.g., when the pigment is first exposed to light), and may provide a greater degree of protection for pigments that are “seasoned” or partially aged (e.g., protection or delay in color change may be greater for pigments or paintings that have already aged somewhat or experienced some degree of photochemical damage or color change). Various other embodiments of the present filters and illuminants can be configured to have similar characteristics.

### Second Prototype Filter

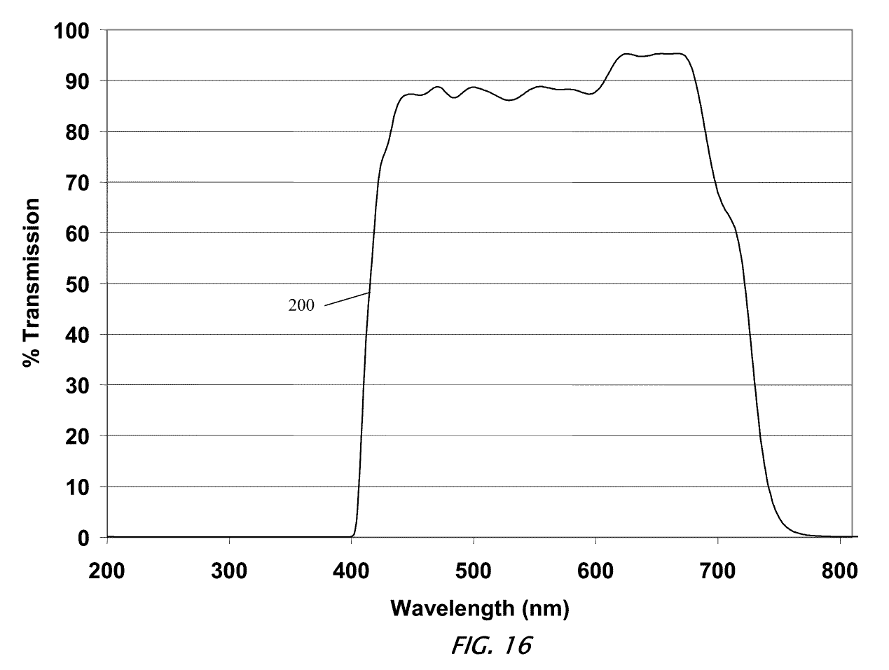

Referring now to FIG. 16, another embodiment of a theoretical customized spectral profile 200 is depicted that is suitable for certain embodiments of the present filters and illuminants. Theoretical customized spectral profile 200 can be implemented in similar ways as customized spectral profile 50 (e.g., as an actual or experimentally-measured customized spectral profile that is substantially similar to customized spectral profile 200). For example, a second prototype filter was designed and manufactured to have a customized spectral profile substantially similar to theoretical customized spectral profile 200. The second prototype filter was designed for a source illuminant (spectrum profile of) Sylvania 58533 lamp, relative to a reference illuminant (spectral profile of) Sylvania 58562. Relative characteristics of the second prototype filter are thus given for light from a Sylvania 58533 (source illuminant) filtered through the second prototype filter, relative to an unfiltered Sylvania 58562 illuminant (reference illuminant). It should be understood that other embodiments of the present filters can be designed to have a customized spectral profile that yields similar characteristics (e.g., CRI, lumens/watt efficiency, power transmission, UV-cutoff, visible-IR cutoff, and/or selective blocking of damaging wavelengths) for any combination of one or more source illuminants and one or more reference illuminants. For example, in one embodiment, the source illuminant can be a Sylvania 58533 illuminant and the reference illuminant can be a Standard A illuminant. In another embodiment, the source or reference illuminant could be sunlight, as in window covering to protect artwork within a room. In other embodiments, the reference could be candlelight, limelight, arc light or mantle-light.

The second prototype filter was physically configured similarly to filter 60 in FIG. 3. Specifically, the prototype filter comprised: a substrate 64, seventeen first filter layers 68, and seventeen second filter layers 72. Substrate 64 comprised 8511 Glass, first filter layers 68 comprised Niobium Pentoxide (Nb₂O₅), and second filter layers 72 comprised Silicone Oxide (Si0₂). First filter layers 68 and second filter layers 72 were deposited by magnetron-sputtering techniques using a Leybold HELIOS coater, available from Leybold Optics, Alzenau, Germany, and possibly also available from Leybold Optics USA, Cary, N.C., U.S.A. First filter layers and second filter layers were deposited in the layer thicknesses listed in Table 6. The filter layer numbered #1 in Table 6 was on or against (e.g., in direct contact with) the substrate (e.g., substrate 64). As with the first prototype filter, a computerized layer model (not shown) was developed for the second prototype filter. The layer model and experimentation (similar to that illustrated above for the first prototype filter) for the second prototype filter determined that the second prototype filter had an actual or experimental customized spectral profile substantially similar to customized spectral profile 200, that can be partially, substantially, or completely described in words with reference to customized spectral profile 200 (e.g., in terms of blocking and/or transmitting above, below, between, or equal to about certain percentages of light, such as, for example, within plus, minus, or plus-or-minus about 1%, 5%, 10%, etc. of customized spectral profile 200, at or between about any wavelengths depicted in FIG. 17.

TABLE 6
Second Prototype Filter Layer Configuration

| | | Layer |
|---|---|---|
| Layer # | Material | Thickness (nm) |
| 1 | Nb₂O₅ | 11.24 |
| 2 | SiO₂ | 33.63 |
| 3 | Nb₂O₅ | 113.71 |
| 4 | SiO₂ | 172.51 |
| 5 | Nb₂O₅ | 104.47 |
| 6 | SiO₂ | 156.21 |
| 7 | Nb₂O₅ | 94.85 |
| 8 | SiO₂ | 153.26 |
| 9 | Nb₂O₅ | 92.85 |
| 10 | SiO₂ | 144.03 |
| 11 | Nb₂O₅ | 96.3 |
| 12 | SiO₂ | 151.77 |
| 13 | Nb₂O₅ | 79.73 |
| 14 | SiO₂ | 164.38 |
| 15 | Nb₂O₅ | 110.53 |
| 16 | SiO₂ | 73.64 |
| 17 | Nb₂O₅ | 117.74 |
| 18 | SiO₂ | 85.22 |
| 19 | Nb₂O₅ | 22.49 |
| 20 | SiO₂ | 27.35 |
| 21 | Nb₂O₅ | 59.29 |
| 22 | SiO₂ | 164.99 |
| 23 | Nb₂O₅ | 75.43 |
| 24 | SiO₂ | 158.53 |
| 25 | Nb₂O₅ | 61.42 |
| 26 | SiO₂ | 34.39 |
| 27 | Nb₂O₅ | 13.68 |
| 28 | SiO₂ | 89.22 |
| 29 | Nb₂O₅ | 107.63 |
| 30 | SiO₂ | 92.98 |
| 31 | Nb₂O₅ | 16.02 |
| 32 | SiO₂ | 28.76 |
| 33 | Nb₂O₅ | 61.4 |
| 34 | SiO₂ | 82.02 |

Similarly to theoretical customized spectral profile 200, the second prototype filter is configured to have a relative power transmission (relative to a Sylvania 58562 reference illuminant at equal luminance) between about 65% and about 75%, (e.g., between about 69% and about 71%, and/or equal to about 70%). The second prototype filter is also configured to have a CRI of more than 95 for the same reference and source illuminants. In particular, CRIs of the layer model and actual prototype filter were calculated using a modified CIE 13.3 method using color difference formula DE00 and using the CIE 109.2 Nayatani adaptation model for each of the Munsell 8 and OMD reflection spectra. Lumens/watt efficiency was also calculated for the layer model and actual second prototype filter. Calculated CRIs and lumens/watt efficiency for each of the layer model and actual second prototype filters are listed in Table 7.

TABLE 7
Layer Model and Experimental Filter Properties
(Second Prototype Filter)

| | CRI (DE00-CIE109.2- | CRI (DE00-CIE109.2- | Lumens/Watt |
|---|---|---|---|
| | OMD) | Munsell {8}) | Efficiency |
| Model | 98.9 | 98.7 | 133% |
| Actual | 99.0 | 98.8 | 133% |
| Filter | | | |

Color rendering was also evaluated using human subjects for the second prototype filter using each of the Farnsworth D15 and L'Anthony D15 color confusion indices (CCIs) for filtered incandescent light from a Sylvania 58533 (filtered through the prototype filter) relative to unfiltered incandescent light from a Sylvania 58562 lamp. The CCIs determined from these evaluations are listed in Table 5. As shown in Table 8, the prototype filter performed very well in that the CCIs for filtered light were very close to the CCIs for unfiltered light. Various other embodiments of the present filters and illuminants can be configured to have similar characteristics.

TABLE 8
Color Confusion Index (Second Prototype Filter)

| | Farnsworth D15 CCI | | L'Anthony D15 CCI | |
|---|---|---|---|---|
| | Filtered | Unfiltered | Filtered | Unfiltered |
| Prototype | 1.00 ± 0.00 | 1.07 ± 0.19 | 1.14 ± 0.21 | 1.23 ± 0.40 |
| (70% P) | | | | |
| (sample = | | | | |
| 15 people) | | | | |

The various illustrative embodiments of devices, systems, and methods described herein are not intended to be limited to the particular forms disclosed. Rather, they include all modifications, equivalents, and alternatives falling within the scope of the claims.

The claims are not intended to include, and should not be interpreted to include, means-plus- or step-plus-function limitations, unless such a limitation is explicitly recited in a given claim using the phrase(s) “means for” or “step for,” respectively.

What is claimed is:

1. A filter comprising:
a substrate;
a plurality of first filter layers comprising a first material, one of the first filter layers in direct contact with the substrate; and
a plurality of second filter layers comprising a second material;
where at least a portion of the first filter layers and at least a portion of the second filter layers are coupled in an alternating configuration; and
where the filter is configured to have a lumens/watt efficiency of more than about 170% and a color rendering index (CRI) of more than about 90, for a source illuminant relative to an unfiltered reference illuminant.

2. The filter of claim 1, where the unfiltered reference illuminant is an incandescent lamp having a color temperature of about 3000K.

3. The filter of claim 2, where the filter is further configured to have a relative power transmission of about between about 50% and about 60%.

4. The filter of claim 3, where the filter is further configured to have a relative power transmission of between about 54% and about 56%.

5. The filter of claim 1, where at least one of the source illuminant and the unfiltered reference illuminant comprises one or more light-emitting diodes (LEDs).

6. The filter of claim 1, where:
the substrate is configured to transmit light having a wavelength above about 400 nanometers (nm) and to substantially block light having a wavelength below about 400 nm;
the first filter layers each comprise Niobium (Nb);
the second filter layers each comprises Silicone (Si); and
the filter is substantially stable at temperatures above 190 degrees Celsius.

7. The filter of claim 6, where the first filter layers each comprise Nb₂O₅.

8. The filter of claim 6, where the second filter layers each comprise SiO₂.

9. The filter of claim 8, where the first filter layers each comprise Nb₂O₅.

10. The filter of claim 9, where the substrate comprises Coming 8511 glass.

11. The filter of claim 9, where:
each of the first filter layers has a thickness between about 5 nanometers (nm) and about 500 nm; and
each of the second filter layers has a thickness of between about 5 nm and about 500 nm.

12. The filter of claim 11, where:
the plurality of first filter layers comprise ten or more first filter layers; and
the plurality of second filter layers comprise ten or more second filter layers.

13. The filter of claim 12, where:
the plurality of first filter layers comprise fifteen or more first filter layers; and
the plurality of second filter layers comprise fifteen or more second filter layers.

14. The filter of claim 1, where the filter is configured such that if light is incident on the filter from a source illuminant, the filter will:
(a) block at least 95% of light having a wavelength below about 400 nanometers;
(b) block at least 95% of light having a wavelength above about 700 nm;
(c) block less than 20% of light having a wavelength between 450 nm and 630 nm and between 530 nm and 570 nm; and
(d) block between about 25% and about 35% of at least one wavelength of light having a wavelength between about 530 nm and about 570 nm.

15. The filter of claim 14, where the filter is configured such that if light is incident on the filter from a source illuminant, the filter will block between about 25% and about 35% of at least one wavelength of light having a wavelength between about 545 nm and about 555 nm.

16. The filter of claim 15, where the unfiltered reference illuminant is an incandescent lamp having a color temperature of about 3000K, and where the filter is configured such that if light is incident on the filter from a source illuminant, the filter will block between about 25% and about 35% of light having a wavelength between about 545 nm and about 555 nm.

17. The filter of claim 1, where the filter is further configured to have a CRI of more than 95.

18. The filter of claim 1, where the filter is configured such that the filtering and mechanical properties of the filter are substantially stable through at least 200 on/off cycles in which the filter is disposed within 12 inches of an incandescent lamp, where each on/off cycle includes one hour during which the lamp is on and one hour during which the lamp is off, and where during the on portion of an on/off cycle the lamp reaches a maximum temperature of at least 180 degrees Celsius.

19. A photopic filter configured such that if light is incident on the filter from a source illuminant, the filter will block substantially all non-visible light, and will have a lumens/watt efficiency of more than about 170% and a color rendering index of more than about 90, relative to an unfiltered incandescent lamp having a color temperature of about 3000K.

20. An illuminant having a customized spectral profile, the illuminant comprising:
one or more light sources;
a plurality of first filter layers comprising a first material; and
a plurality of second filter layers comprising a second material;
where at least a portion of the first filter layers and at least a portion of the second filter layers are coupled in an alternating configuration; and
where the illuminant is configured to have a lumens/watt efficiency of more than about 170% and a color rendering index (CRI) of more than about 90, relative to an unfiltered reference illuminant that comprises an incandescent lamp having a color temperature of about 3000K.

21. The illuminant of claim 20, where the one or more light sources comprise three or more light-emitting diodes (LEDs).

22. The illuminant of claim 21, where the one or more light sources comprise more than three LEDs.

23. The illuminant of claim 20, where the one or more light sources comprise an incandescent lamp.

24. The illuminant of claim 20, where the one or more light sources comprise a substrate, and where one of the first filter layers is in direct contact with the substrate.

25. The illuminant of claim 20, where the first filter layers and second filter layers are spaced apart from the one or more light sources.
